(19) United States
(12) Patent Application Publication
(10) Pub. No.: US 2008/0063202 A1
(43) Pub. Date: Mar. 13, 2008

(54) Reconfigurable handheld device to perform various tasks

(76) Inventor: Michael Zhu, San Jose, CA (US)

Correspondence Address: Michael Zhu, 1156 Fairford Way, San Jose, CA, 95129, US

(21) Appl. No.: 11/530,967

(22) Filed: Sep. 12, 2006

(51) Int. Cl. H04K 1/00

(52) U.S. Cl. 380/255

(57) ABSTRACT

The present invention relates in general a reconfigurable handheld device that can be used for multiple tasks, such as cell phone, TV receiver, video image transmitter, radar frequency scanner, surveillance terminal, approaching object warning system etc. The invention presents the program downloadable over network to add/sub the capabilities of the handheld devices. The invention presents the way to do real time encoding and compression to make video, audio, text or control message transmission with much less bandwidth needs. The invention presents the way to do quick, low power real time decoding and decompression of the messages received. The invention presents the new application of Radar related in handheld devices. The invention presents the infrastructure of using handheld terminal as surveillance network and database network. The invention presents the multiple iterations of variable length coding to save bandwidth.

### FIELD OF INVENTION

The present invention relates in general a reconfigurable handheld device that can be used for multiple tasks, such as cell phone, TV receiver, video image transmitter, radar frequency scanner, surveillance terminal, approaching object warning system etc.

### BACKGROUND OF THE INVENTION

A handheld device has limited resources to perform the tasks mentioned above. The handheld devices with this many capabilities may be impractically huge. The present invention presents several ways to make it practical to perform above mentioned tasks in one handheld terminal.

The handheld terminal has built-in basic components of transmitter, receiver, processor, storage space, camera, mic, speaker, keypad and screen. The re-configuration of different basic blocks may make the handheld terminal performing different tasks.

The handheld terminal can be used as cell phone. Also it can be used as TV receiver. Also it can be used as radar transmitter and receiver. When executing different control program, it can be used as radar-detector, approaching objects warning system, collision warning system. It can be used as surveillance device with camera enabled. It can be used to exchange video message, deposit the video clip into the data bases etc.

Nobody even has promoted to have cell-phone, PDA type of handheld device to perform radar related tasks. The present invention promotes to receive both broadcast TV or cellar network TV through reconfiguration of the handheld terminal.

### SUMMARY OF THE INVENTION

The invention presents the program downloadable over network to add/sub the capabilities of the handheld devices. The invention presents the way to do real time encoding and compression to make video, audio, text or control message transmission with much less bandwidth needs. The invention presents the way to do quick, low power real time decoding and decompression of the messages received. The invention presents the new application of Radar related in handheld devices. The invention presents the infrastructure of using handheld terminal as surveillance network and database network. The invention presents the multiple iterations of variable length coding to save bandwidth.

### BRIEF DESCRIPTION OF DRAWING

The present invention is illustrated by way of example and not by way of limitation, in the figure of the accompanying drawings and in which like reference numerals refer to similar elements.

FIG. 1 illustrates a handheld device with basic components according to one embodiment of the present invention.

FIG. 2 illustrates the steps performed by the reconfigurable devices in accordance with one embodiment of the present invention in the form of flow chart.

FIG. 3 illustrates the steps performed by multiple iterations of variable length coding to save bandwidth according to one embodiment of the present invention.

FIG. 4 illustrates the infrastructure to use handheld device to form a surveillance device according to one embodiment of the present invention.

FIG. 5 illustrates the various radar related application according to one embodiment of the present invention.

FIG. 6 illustrates the main components of video clip databases based on one embodiment of the present invention.

FIG. 7 illustrates the self adaptive decoding of variable length coding

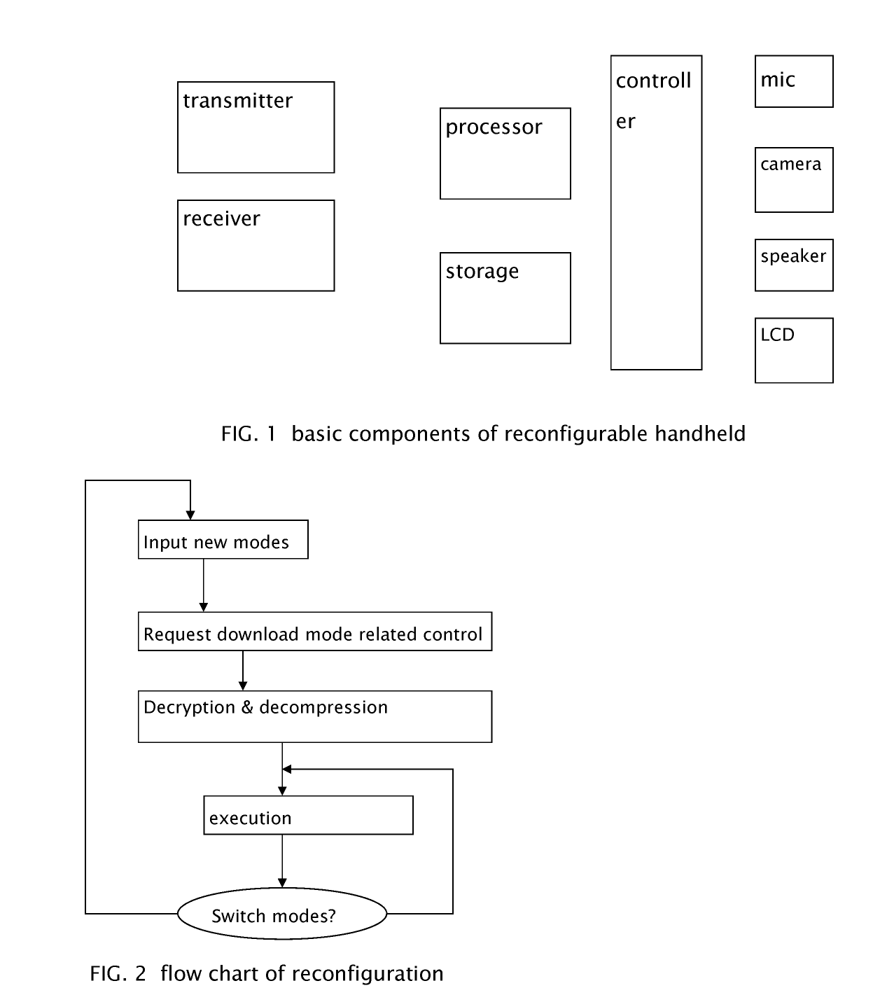

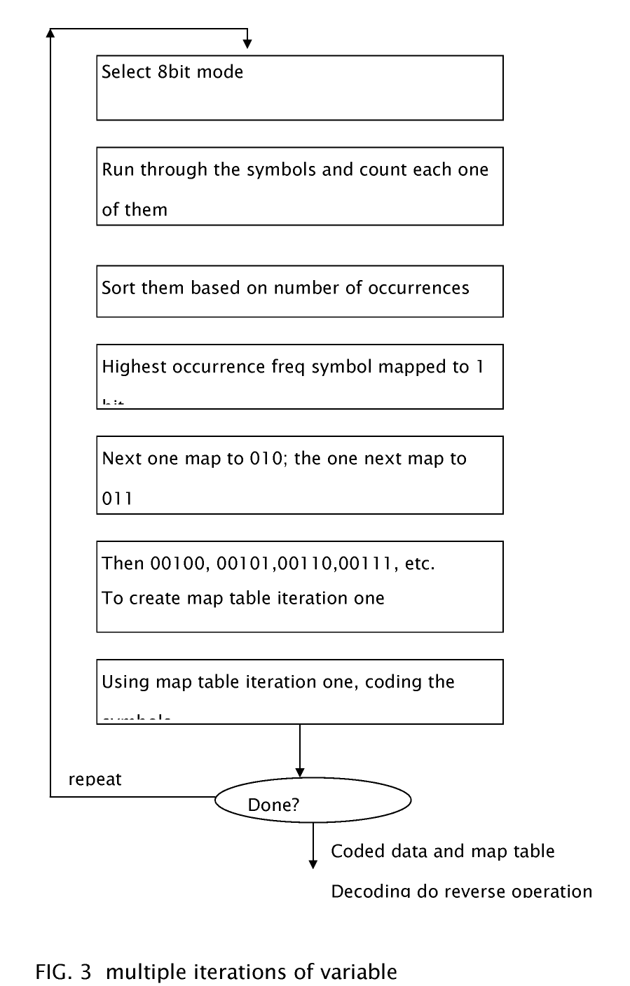

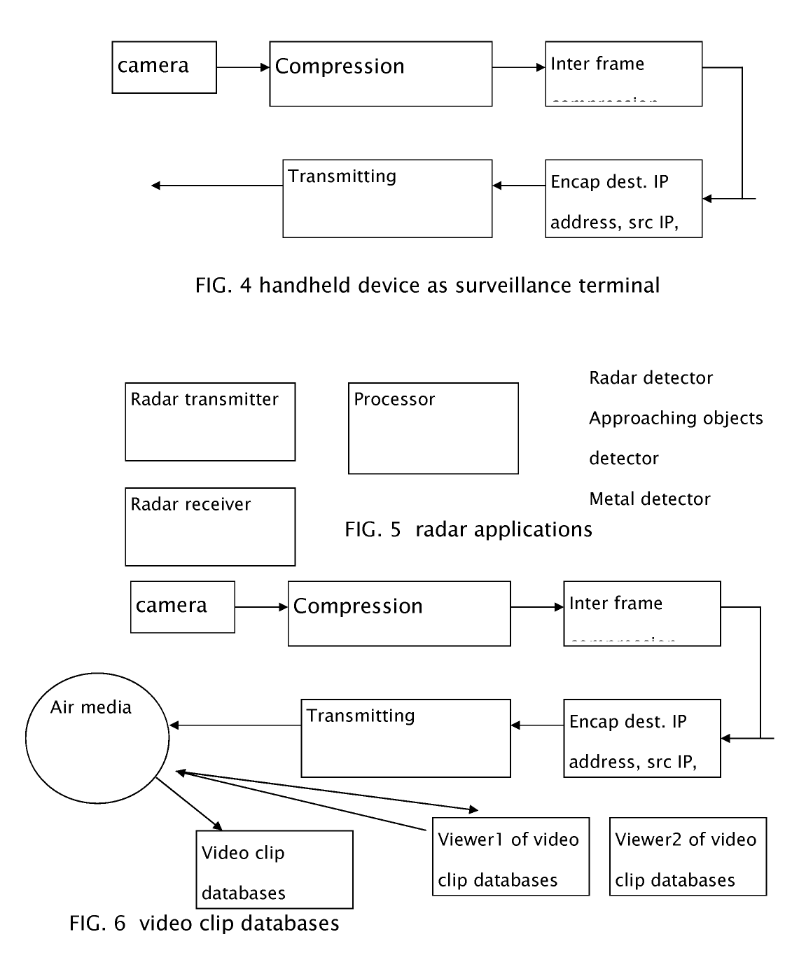

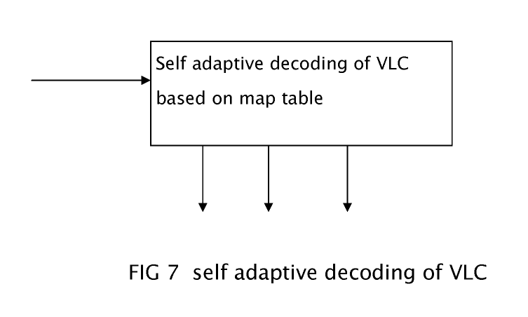

What is claimed is:

a. A system of downloadable compressed, crypto control program may instruct the handheld device to execute the different tasks.

b. A method to perform real time compression and crypto encoding with limited resource on handheld device.

c. A method to perform real time decryption and decompression with limited resource on handheld device.

d. A method to use handheld device as radar transmitter and receiver.

e. An infrastructure to use handheld devices as surveillance network.

f. An infrastructure to use handheld devices to generate a video clip database.

g. The method of multiple iterations of variable length coding is selected to save the bandwidth.

h. A set of applications including radar detection, radar scan, moving objects detection and warning may be introduced to handheld devices of claim 4.

i. A method of claim 7 wherein a self adaptive decoding of variable length coding
